(19) United States
(12) Patent Application Publication
(10) Pub. No.: US 2013/0298726 A1
(43) Pub. Date: Nov. 14, 2013

(54) LINK ELEMENT WITH OVERLOAD PROTECTION MEANS

(71) Applicants: Jens Diekhoff, Lemforde (DE); Cord Fricke, Dickel (DE); Frank Scheper, Loeningen (DE); Frank Nachbar, Osnabruck (DE); Alfons Nordloh, Visbek (DE)

(72) Inventors: Jens Diekhoff, Lemforde (DE); Cord Fricke, Dickel (DE); Frank Scheper, Loeningen (DE); Frank Nachbar, Osnabruck (DE); Alfons Nordloh, Visbek (DE)

(73) Assignee: ZF Friedrichshafen AG, Friedrichshafen (DE)

(21) Appl. No.: 13/883,787

(22) PCT Filed: Oct. 18, 2011
(86) PCT No.: PCT/EP2011/068142

§ 371 Date: Jun. 26, 2013

(30) Foreign Application Priority Data
Nov. 11, 2010 (DE) 10 2010 043 778.6

(51) Int. Cl. F16C 7/02

(52) U.S. Cl. CPC F16C 7/02
USPC 74/579 R

(57) ABSTRACT

A link element for coupling two assemblies with one another. The link has rod-shaped sections that are connected by an overload protection but are able to move axially relative to one another if subjected to an overload. The overload protection comprises a shear element which rigidly connects the link sections, in a form locking manner, and has a stop for limiting relative axial movement of the link sections, if subjected to an overload. The link element provides a defined deformation path, in the event of failure, and remains functional to a limited extent even once an overload occurs. The link element, when used on a chassis of a vehicle, signals to the driver damage or overload in the chassis, without further components or devices.

This application is a National Stage completion of PCT/EP2011/068142 filed Oct. 18, 2011, which claims priority from German patent application serial no. 10 2010 043 778.6 filed Nov. 11, 2010.

### FIELD OF THE INVENTION

The invention relates to a link element comprising at least two substantially rod-shaped link sections having an overload protection means for the coupling connection of two assemblies or components.

### BACKGROUND OF THE INVENTION

Link elements of the type in question, which are specified in the introduction, are used, for example, although by no means exclusively, in motor vehicles in the form of links or tie rods for the wheel suspension or the steering system. Such link elements are implemented therein in order to transfer pressure and tension forces and, therefore, for example, to guide the wheels and—in the case of steered axles—to adjust the desired steering angle at the wheel mount.

In vehicle manufacturing, in particular, high demands are placed on such link elements, including, in particular, a high load-carrying capacity and endurance limit, a high level of protection against failure and high corrosion resistance. At the same time, such link elements should take up a minimum of installation space in order to prevent potential collisions with adjacent assemblies, and to ensure unrestricted freedom of movement of other components and assemblies in the region of the chassis.

Overall, link elements of the type in question are therefore components that are crucial to the driving safety of the motor vehicle and are therefore often dimensioned with a high degree of stiffness and failure safety. In addition to basic requirements for low costs and low mass, however, a failure behavior in the event of a crash or overload that can be controlled as exactly as possible is of increasing and decisive significance for link elements in particular.

Proceeding therefrom, link elements or tie rods, which are known from the prior art, on motor vehicles often have a defined failure safety or buckling stability, in particular upon transfer of pressure forces, or single-acting or double-acting overload protection means are provided that permit the link or the tie rod to undergo controlled deformation or length extension, with energy absorption, when a defined tension or pressure load is exceeded. In this manner, a controlled build-up of energy in the event of a crash is supported and adjacent components (such as spindles or steering gears) are protected against destruction.

Such overload protection means for link elements of the type in question have often been designed in the prior art as corrugated tube sections, as friction elements, or as sheet-metal strip arrangements or wire arrangements designed to be reversed or unwound. Examples thereof are known from the document DE 39 15 991 A1.

These known overload protection means, some of which are also double-acting, have several disadvantages depending on the design. For example, solutions having corrugated tubes have axial resilience and flexural elasticity, which are unwanted during normal operation of a link element and even when low loads are incurred. Overload protection means having sheet-metal strips designed to be reversed or wire spirals designed to be unwound are structurally complex and therefore expensive, may require additional friction elements in order to achieve the desired operative stiffness, and take up a considerable amount of radial installation space.

A further requirement on such link elements having overload protection means is that these link elements must not fail completely or become separated even in the event of high overload, in order to ensure the basic driveability and steerability of the vehicle, even in the event of failure. Finally, it is also desirable for the driver of the motor vehicle to be signaled immediately if the overload protection means of a link element in the chassis may have been activated, i.e. if the safety-relevant region of the steering system or the wheel suspension may have become damaged due to overload. After an overload protection means has been activated, the driver should therefore be clearly signaled that the vehicle or the wheel suspension requires inspection and should not be operated further.

Finally, due to current developments in the field of chassis engineering in particular, the forces generated in link elements, for example tie rods, as a result of operative loads and unusual events, and the required failure force window are located increasingly closer to one another, but still must be differentiated by an associated overload protection means, and therefore an overload protection means must reliably and reproducibly distinguish between an operative load and a failure load, even under these conditions.

These requirements are likewise unmet by the solutions known from the prior art, or are not met to the desired extent, in particular not in combination.

### SUMMARY OF THE INVENTION

Proceeding therefrom, the problem addressed by the present invention is that of creating a link element having an overload protection means, with which the aforementioned disadvantages of the prior art can be overcome. In particular, the link element should have the defined failure behavior in the event of a crash or overload that is desired in the chassis region, that is, the link element should provide a high degree of stiffness during normal operation while, simultaneously, the failure load should be exactly definable and always reproducible, and, after failure, a certain deformation path should be followed, wherein, in the event of an overload or a further increase in force, the component should not initially fail entirely. In addition, the vehicle should remain driveable and steerable even in the event of failure, and the overload that occurred in the chassis should be clearly signaled to the vehicle driver. Last but not least, the link element should be easily adaptable in the sense of a modular design to different basic conditions and customer requirements, in particular with respect to the failure loads.

This comprehensive problem is solved by means of a link element according to the invention.

The link element according to the invention is also used, in a manner known per se—as a tie rod, for example—for the coupling connection of two assemblies or components, preferably on the chassis of a motor vehicle, and, to this end, comprises two substantially rod-shaped link sections. The link sections of the link element are connected to each other—also in a manner that is known per se—by means of an overload protection means, and can move relative to each other in the event of an overload.

According to the invention, the link element is characterized in that the overload protection means comprises at least one metallic shear element, which rigidly connects the two link elements in a form locking manner. The shear element is selectable and interchangeable in a modular manner, and the overload protection means has at least one rigid end stop for limiting the axial path of relative movement of the two link sections in the event of an overload.

The metallic shear element has the advantage of being capable of transferring high forces along the longitudinal direction of the link element in the smallest possible space, wherein, simultaneously, the failure force, i.e. the longitudinal force in the link element that shears off the shear element, is reliably reproducible and can be maintained over the service life of the link element and, to the greatest extent possible, independently of any temperature fluctuations within narrow tolerance limits. In this manner, the narrow window of functionality with respect to the reproducible level of shear forces, which is increasingly required for the application, can be structurally implemented and maintained over the long term.

In addition, the metallic shear element can be inspected—in terms of the dimensions and material properties thereof—before the production or installation of the link element with respect to adherence to the tolerances that determine the shear forces. In this manner it can be ensured that the required window of functionality is actually maintained during operation of the link element or the overload protection means.

According to the invention, the shear element of the overload protection means is selectable and interchangeable in a modular manner. As a result, the overload protection means and, therefore, the link element, can be very easily adapted to different customer requirements with respect to the failure forces of the link element via a relatively simple selection or adaptation of the shear element that is used, wherein, simultaneously, the remaining dimensions and components of the link element remain virtually unchanged.

According to the invention, the overload protection means also comprises a rigid end stop for limiting the axial path of relative movement of the two link sections in the event of an overload. In this manner it is clearly ensured that the link element maintains the basic functionality thereof in the event of an overload, in which the shear element therefore fails and shears off, without the link sections of which the link element is comprised becoming separated from one another, with the potential loss of driveability or steerability of the motor vehicle.

In contrast to the solutions known from the prior art, in which, for example, overload protection means having deformation elements are used, the use of a metallic shear element in combination with a limited axial path of relative movement of the two link elements in the event of an overload also results in the generation of a low-force but limited axial play of the two link sections with respect to each other after the abrupt failure of the shear element. Therefore, the vehicle continues to be driveable and maneuverable, and the vehicle driver (when a tie rod is used, for example) is very noticeably signaled, via the steering play that suddenly occurs in the steering wheel, that damage must have occurred in the region of the chassis or the steering system.

According to preferred embodiments of the invention, the shear element can be sheared along both axial directions of the link element, and the overload protection means provides an axial path of relative movement and an end stop along each of the two axial directions of the link element.

This embodiment has the advantage that the overload protection means can be designed to function in the tension direction and in the pressure direction. The shear element is therefore sheared off in the event of an axial overload in either the tension direction or the pressure direction of the link element, wherein, simultaneously, an axially limited play occurs within the overload protection means in each case, the overload protection means ensuring the functionality of the link element after an overload occurs and performing the function of signaling the vehicle driver.

According to a further preferred embodiment of the invention, the first and second link sections coaxially engage into each other in the region of the overload protection means, wherein the second link section is sleeve-shaped in the overlap region and accommodates the end of the first link section assigned to the overlap region. For this, the first and second link sections can have, or form, a cone fit, in particular, within the overlap region.

The coaxial reciprocal engagement, in particular by means of a cone fit, results in an exact and play-free retention of the relative position of the two link sections in the overlap region, even when subjected to a load, for example under a flexural load of the link element. In this manner, undefined flexural loads are also transferred via the mutual coaxial engagement, or via the cone fit between the two link sections, without the shear element being notably or unsymmetrically loaded as a result. This embodiment therefore also improves the sustained reliability of the link element in terms of maintaining the window of functionality and the structurally intended failure forces of the overload protection means.

The invention can be clearly implemented independently of the shape and structural design of the shear element, provided the shear-off cross sections required for the particular failure forces that are required are achieved. According to a preferred embodiment of the invention, the shear element is designed as a shear pin. In that case, the first and second link sections of the link element at least partially overlap each other in the axial direction in the region of the overload protection means. Preferably, the shear element extends through the first and the second link sections in the overlap region along the entire diameter of the overlap region.

The embodiment of the shear element as a shear pin, which also preferably extends completely through the link sections, which preferably coaxially overlap each other, results in a cost-favorable embodiment of the overload protection means in that the overlapping link sections are provided, in the installed state, with a simple through-hole, which, in turn, accommodates the shear pin. In this manner it is also possible to easily achieve the modular interchangeability of the shear element and the associated adaptability of the overload protection means to different basic conditions or customer requirements by selecting the bore and pin diameters in such a way that the intended shearing force results.

According to a further preferred embodiment of the invention, the shear element is designed as a circular shear disk disposed in the overlap region of the link sections. Preferably, the shear pin is connected in a form locking manner to the first and/or to the second link section in each case by means of a clamping ring, which is disposed at the respective link section in a form locking manner.

The embodiment of the shear element as a shear disk is advantageous in that it is possible thereby to reliably achieve high shear forces and within a small component volume of the overload protection means. The form locking connection of the shear disk to the particular link sections by means of a clamping ring in each case is advantageous in that the overload protection means can be modularly adapted thereby to different thicknesses and/or diameters of the shear disk without the need to make any other notable changes to the overload protection means or the link element. The clamping rings for connecting the shear disk to the link sections are preferably connected in a form locking manner to the particular link section by means of threads or shaping, for example rolling.

The invention is clearly obtained independently how the limited axial play or the limited axial path of relative movement of the two link sections in the event of an overload is structurally implemented. According to a preferred embodiment of the invention, a means for limiting the axial path of relative movement along at least one axial direction of the link element is formed by two axially separated, inner and outer radial projections of the overload protection means. The inner radial projection is integrally disposed on the first link section within the overlap region of the link sections, and the outer radial projection is integrally disposed on a clamping ring assigned to the second link element.

In this manner, at least the clamping ring assigned to the second link element obtains a structural dual function in that the clamping ring is used for the form locking fastening of the shear disk at the second link element, and simultaneously provides or forms the axial play and the axial stop in the event of an overload. In this manner as well, the axial stop can be formed in a structurally robust and cost-favorable manner by integrally disposing the two radial projections on the first link section and on the clamping ring, respectively. The clamping ring can also be installed in this manner simply by being around the first link section, thereby forming the axial stop, without the need to shape one of the components that is used.

According to an alternative embodiment, a means for limiting the axial path of relative movement along at least one axial direction of the link element is formed by two axially separated, inner and outer radial projections of the overload protection means, wherein the inner radial projection is also integrally disposed on the first link section within the overlap region of the link sections, while the outer radial projection is integrally disposed here, in the form of a radially inwardly shaped indentation, on the second link section, which is sleeve-shaped in the overlap region. This embodiment is structurally particularly simple, in particular since the embodiment comprises a minimum number of parts. In other words, the axial path of relative movement in the event of an overload is formed in this embodiment in that the first link section, which has an outer radial projection disposed therein, is introduced into the sleeve-shaped end of the second link section, whereupon the sleeve-shaped end of the second link section is shaped radially inwardly in such a way that the end of the first link section having the outer radial projection disposed thereon is enclosed in the sleeve-shaped end of the second link section in a form locking manner, but with limited axial play.

According to a further alternative embodiment of the invention, a means for limiting the axial path of relative movement in the event of an overload is formed by two axially separated, inner and outer radial projections of the overload protection means, wherein the inner radial projection is also integrally disposed on the first link section within the overlap region of the link sections, while the outer radial projection is disposed, in the form of a stop ring integrally formed in the radial direction, on the second link element, which is sleeve-shaped in the overlap region. Due to the integrally formed stop ring, the axial path of relative movement provided according to this embodiment results in a particularly robust axial stop of the two link sections in the axial direction and is therefore suited in particular for highly loaded link elements.

According to a further particularly preferred embodiment of the invention, the overload protection means and the shear element are disposed in a protective housing enclosing the link element in the region of the overload protection means. Preferably, the protective housing encloses the overload protection means having the shear element adjacently on all sides and encloses the link ends acting on the overload protection means radially without gaps. Due to the protective housing, which encloses—preferably adjacently on all sides—the overload protection means and the link ends of the link element acting on the overload protection means, the result is a tight enclosure of the overload protection means and, therefore, protection against environmental influences and corrosion. In addition, the enclosure of the overload protection means and the link ends via the protective housing results in a stiffening of the region of the overload protection means against bending and, therefore, also contributes to the functional reliability of the overload protection means and the link element.

Proceeding therefrom, according to a further embodiment of the invention, a means for limiting the axial path of relative movement in the event of an overload is also formed by two axially separated, inner and outer radial projections of the overload protection means, wherein the inner radial projection is also integrally disposed on a link section, while the outer radial projection in this case is formed by a radial indentation of the protective housing. The outer radial projection, as a stop for the axial path of relative movement, can be formed, in particular, by a cross-sectional transition of the protective housing in the region of the link ends acting on the overload protection means. As a result of this embodiment, the protective housing is multifunctional in terms of corrosion protection of the overload protection means and in terms of the stiffening of the overload protection means with respect to bending, and as an axial path limitation for the relative movement of the link sections in the event of an overload.

According to a further preferred embodiment of the invention, a means for limiting the axial path of relative movement in the event of an overload along at least one axial direction is formed by a stop pin, which extends radially through the two link elements in the overlap region thereof. The stop pin extends through at least one of the two link sections in the overlap region in a slot oriented axially with respect to the link element. In this manner, a structurally particularly simple and cost-favorable embodiment of the link element having overload protection means is obtained, for example, in that the two link sections are coupled to each other via two connecting pins, wherein one of the connecting pins functions as a shear element and the second connecting pin—via interaction with the slot of one of the link sections—functions as a stop element for the axial path of relative movement in the event of an overload.

Finally, according to further embodiments of the invention, the first and/or second link sections are designed at the ends thereof facing away from the overload protection means to accommodate, in a form locking manner, a further link section or the shank of a ball joint; or the first and/or second link sections are integrally formed with the joint ball on the end thereof facing away from the overload protection means. The overload protection means is thereby integrated into a link element in a structurally simple and cost-favorable manner with a minimum of component complexity.

### BRIEF DESCRIPTION OF THE DRAWINGS

The invention is explained in the following in greater detail with reference to drawings that merely depict exemplary embodiments. Therein:

FIG. 1 shows a link element without an overload protection means according to the prior art;

FIG. 2 shows an embodiment of a link element according to the invention having an overload protection means, in a half section;

FIG. 3 shows, in a representation corresponding to FIG. 2, a further embodiment of a link element according to the invention having an overload protection means;

FIG. 4 shows, in a representation corresponding to FIGS. 2 and 3, a further embodiment of a link element according to the invention having an overload protection means;

FIG. 5 shows a further embodiment of a link element according to the invention having an overload protection means, in a longitudinal view;

FIG. 6 shows a further embodiment of a link element according to the invention having an overload protection means; and

FIG. 7 shows the link element according to FIG. 6 in a longitudinal view.

### DETAILED DESCRIPTION OF THE PREFERRED EMBODIMENTS

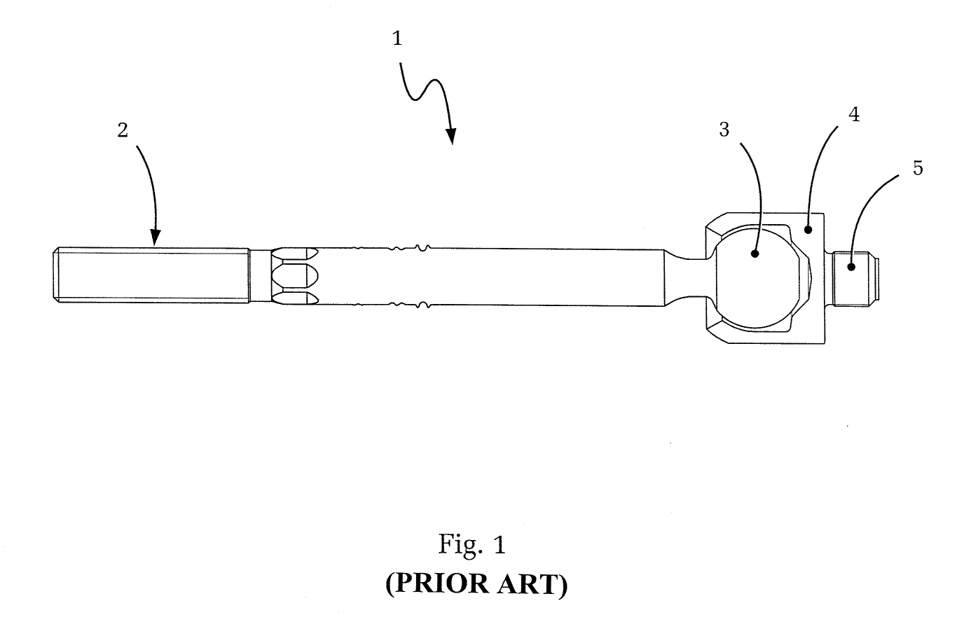

FIG. 1 shows a link element without an overload protection means according to the prior art. A rod-shaped link section 1 is shown, wherein the link section has, on the left side as shown in the drawing, a thread 2 for connection, for example, to a further link section or to a connecting component. On the right side, as shown in the drawing, the link section integrally comprises a joint ball 3, which, in the representation according to FIG. 1, is accommodated in an articulated manner in a joint housing 4 having a connecting thread 5.

The link element represented in FIG. 1 therefore does not have an overload function that goes beyond a simple buckling of the link section 1 in the event of an overload in the pressure direction. Even if the prior art utilizes, in part, a through-extension (i.e. a profile of the link section 1 that is bent or curved in some regions, as in the case of a tie rod, for example) and this through-extension is designed for a certain buckling load in the tension and/or pressure direction, it would still not be possible to provide the narrow window of functionality with respect to the intended failure forces and with respect to further functions as is required according to current requirements.

The level of the failure force acting on a link element designed to fail by buckling cannot be reproduced with sufficient accuracy, nor does the force-displacement-failure curve correspond to the increasingly desired, defined failure curve having an initially steep increase up to the failure point (i.e. with high link stiffness before failure), followed by a slight or severe drop of the deformation force, and finally having a low level of force that is as consistent as possible along the entire (and limited) deformation path. The task of signaling an overload or damage that has occurred in the chassis or in the steering system of a motor vehicle, for example, due to a localized, abrupt failure and subsequent generation of limited axial play which can be easily perceived by the vehicle driver at the steering wheel, is not implemented by the link elements known from the prior art, regardless of whether they have overload protection means or not.

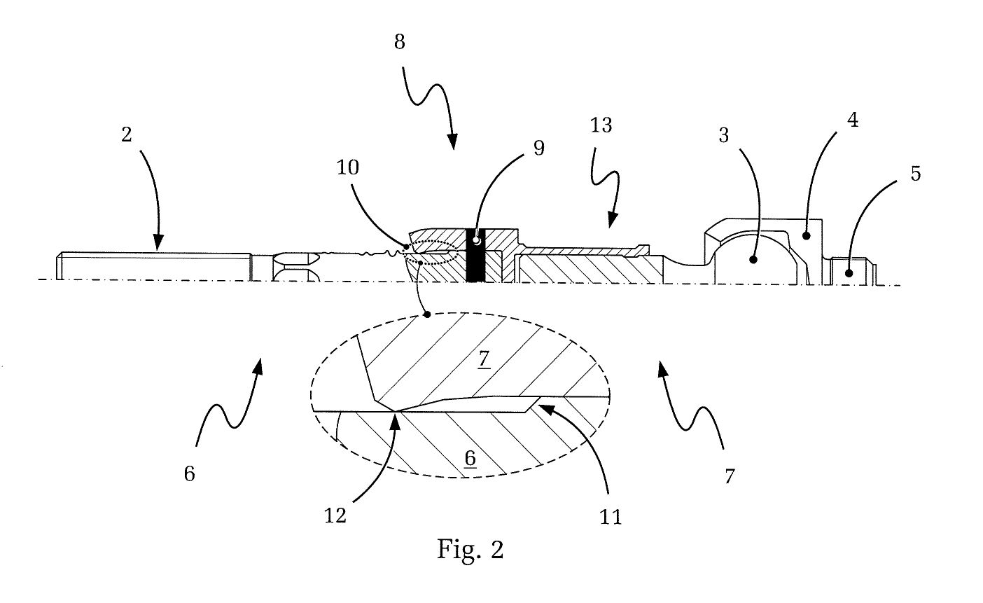

In contrast thereto, FIG. 2 shows an embodiment of a link element according to the invention having an overload protection means. Two link sections 6 and 7 are shown, which are connected to each other via an overload protection means 8. The overload protection means 8 has a metallic shear element 9, which is designed as a shear pin in this case (shown in black in FIG. 2). The overload protection means 8 according to the invention further comprises a rigid end stop 10. The end stop 10 limits the axial path of relative movement of the two link sections 6 and 7 in the event of an overload (i.e. when the shear pin 9 shears off due to overload) in that an inner radial projection 11 disposed on the first link section 6 impacts an outer radial projection 12 disposed on the second link section 7.

In this manner, the two link sections 6 and 7 remain connected to each other even in the event of an overload and after the shear pin 9 has sheared off, and the vehicle retains limited functionality and maneuverability (assuming, for example, that the link element is used as a tie rod). Due to the axial play generated between the two link sections 6 and 7, and between the inner 11 and outer radial projections 12, which can be perceived by the vehicle driver at the steering wheel after an overload has occurred, the vehicle driver thereby receives a clear signal that there is a problem or damage in the region of the chassis or the steering system.

In the embodiment of the link element according to the invention as depicted in FIG. 2, the outer radial projection 12 is implemented on the second link section 7, which is sleeve-shaped in the region of the overload protection means 8, the outer radial projection being implemented in the form of an indentation at 12, which is shaped radially inwardly after the two link sections 6, 7 are assembled via joining.

In the embodiment of the link element according to the invention depicted in FIG. 2, the diameter and material of the shear pin 9, which is the shear element in this case, can each be selected in the sense of a modular design in such a way that precisely those failure forces required according to basic conditions or customer requirements are achieved. In order to complete the link element 6, 7, 8, all that is left to do is to form the appropriately sized through-hole through the joined ends of the link sections 6, 7 and press the shear pin 9 therein.

In the embodiment shown, a ball pin having a joint ball 3 is accommodated in a further sleeve-shaped region 13 of the link element 7 shown on the right in the drawing. The sleeve-shaped region 13 of the link element 7 can be connected to the ball pin 3 by means of a thread or by radially pressing the sleeve-shaped region 13 onto the surface (which may have recesses, in the sense of a form locking connection) of the cylindrical region of the ball pin 3 in the connection region.

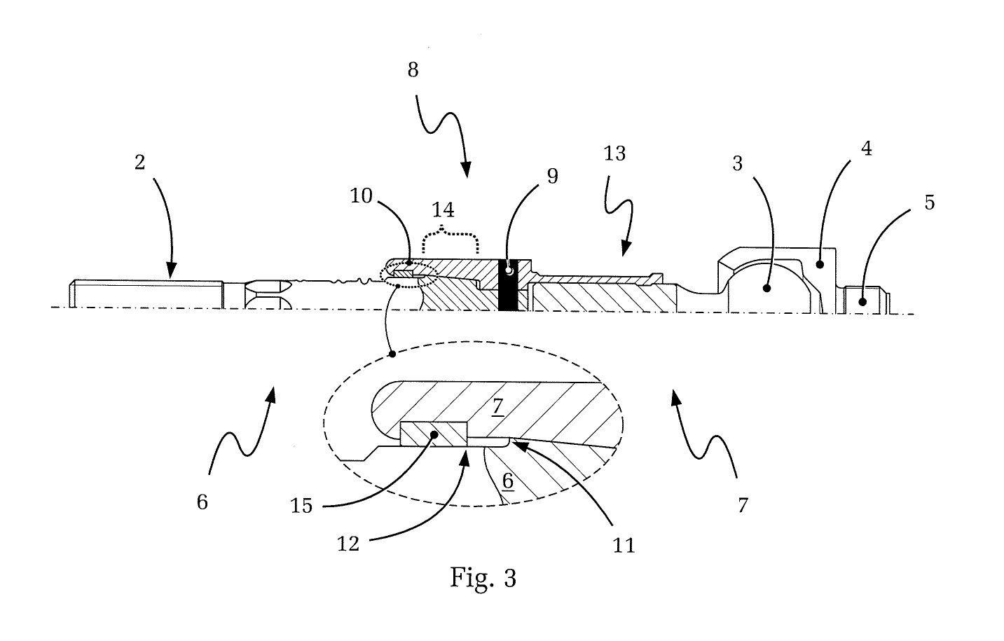

FIG. 3 also shows a link element having an overload protection means 8 according to the invention. The overload protection means 8 has a cone fit 14 between the two joined ends of the link sections 6, 7. The cone fit 14 makes it possible to maintain, in an accurate and play-free manner, the relative position of the two link sections in the overlap region even under load, in particular upon flexural loading of the link element. Therefore, undefined flexural loads are also transferred via the cone fit 14 between the two link sections 6, 7 without a substantial or unsymmetrical load being placed on the shear pin 9. As a result, the reliability of the overload protection means 8 is ensured, in particular in terms of the reproducibility of the window of functionality and the structurally intended failure forces.

A further difference of the embodiment according to FIG. 3 with respect to the embodiment according to FIG. 2 is that the end stop 10 in the embodiment according to FIG. 3 is formed via the interaction of the inner radial projection 11 disposed on the first link section 6 with a radially integrally formed stop ring 15. The limitation of the axial path of relative movement of the two link sections 6, 7 by the integrally formed stop ring 15 provides a particularly robust axial stop in the axial direction and is therefore suitable in particular for highly loaded link elements. After the two link sections 6, 7 have been joined, the stop ring 15 is connected to the link element 7 at 10 by shaping the edge of the sleeve-shaped receptacle on the link element 7 in the region of the overload protection means 8.

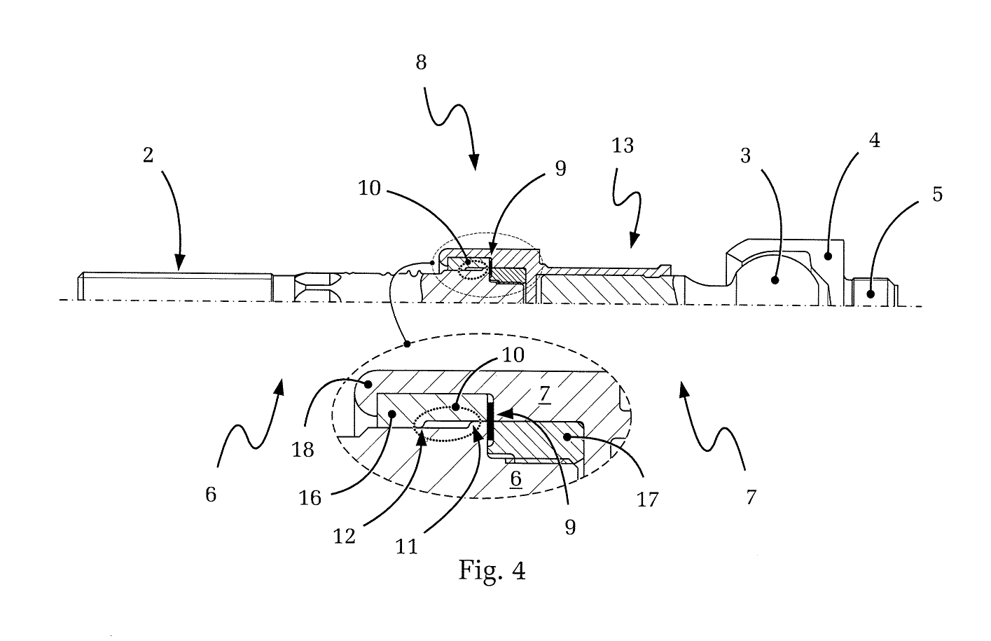

FIG. 4 shows a further embodiment of a link element having an overload protection means according to the invention. In contrast to the embodiments according to FIGS. 2 and 3, the shear element in the embodiment according to FIG. 4 is designed as a shear disk 9 having the shape of a circular ring (shown in black in FIG. 4). The shear disk 9 is connected to the two link sections 6 and 7 by means of a clamping ring 16 and 17, respectively. In the embodiment shown, the clamping ring 17 shown on the right in the drawing is connected to the link section 6 shown on the left in the drawing by means of a threaded fitting and, together with an assigned projection on the end of the link section 6 shown on the left in the drawing, encloses a radially inner surface region of the shear disk 9 in a clamping manner, whereupon the shear disk 9 is connected in a form locking manner to the link section shown on the left in the drawing.

At the same time, the shear disk is also connected in a form locking manner to the link section 7 shown on the right in the drawing via the interaction of the clamping ring 16 shown on the left in the drawing with the link section 7 shown on the right in the drawing. In the embodiment shown, the clamping ring 16 and the link section 7 are connected by shaping the edge 18 of the sleeve-shaped receptacle of the link element 7 in the region of the overload protection means 8, and therefore the clamping ring 16 is ultimately connected to the link section 7 in a form locking manner and simultaneously encloses the radially outward region of the shear disk 9 in a clamping, form locking manner.

In other words, the radially outward region of the shear disk 9 is connected in a form locking manner to the link section 7 shown on the right in the drawing, and the radial inner region of the shear disk 9 is connected in a form locking manner to the link section 6 shown on the left in the drawing, whereupon the two link sections 6, 7 are therefore coupled to each other in a form locking manner and without play. When an overload occurs along the axial direction of the link element (in the tension direction in the present embodiment), the shear disk 9 is therefore sheared off at the transition line between the radially inner or outer surface region of the shear disk 9, and the overload protection means or the link element therefore abruptly fails.

Due to the properties, according to the invention, of the link elements shown, the failure of the shear disk 9 (FIG. 4) or the shear pin 9 (FIGS. 2, 3, 5 and 6) therefore does not result in a loss of maneuverability of the motor vehicle equipped therewith (in the form of a tie rod, for example). Instead, according to the invention, the shearing off of the shear disk 9 or the shear pin 9, in the case of the link elements shown, merely results in the axial path of relative movement being released, whereupon, in the case presented as an example, a corresponding amount of play abruptly becomes noticeable at the steering wheel of the motor vehicle, thereby signaling to the vehicle driver that an overload has occurred in the chassis. The basic functionality of the link element is retained, however, since the axial path of relative movement in the event of failure of the shear disk 9 or the shear pin 9 is limited by the respective axial end stop 10 of the overload protection means, thereby preventing the link sections 6, 7 of the link element from becoming separated from each other.

In the embodiment according to FIG. 4, the axial end stop 10 is formed by an inner radial projection 11 on the link section 6 shown on the left in the drawing in interaction with an outer radial projection 12 on the clamping ring 16 of the link section 7 shown on the right in the drawing. The clamping ring 16 is thereby provided with a structurally advantageous dual function in that this clamping ring clamps the radially outer region of the shear disk 9 and provides the outer radial projection 12 for limiting the axial path of relative movement in the event of failure.

In the embodiment shown, the link element according to FIG. 4 is designed to fail in the event of an overload and to provide a corresponding axial path of relative movement in the tension direction. An overload protection means in the pressure direction as well can be achieved in a manner known per se by means of a suitable buckling design of the link element. The link element according to FIG. 4 can also be easily designed to be double-acting by making a minor change to the geometry in the region of the end of the link section 6, which is shown on the left in the drawing, and the clamping ring 17 disposed there, which is shown on the right in the drawing. It is thereby possible to obtain a defined failure in the event of an overload while providing a corresponding axial path of relative movement in the event of an overload in either the tension direction or in the pressure direction. The same applies similarly to the embodiment of the link element according to FIG. 2.

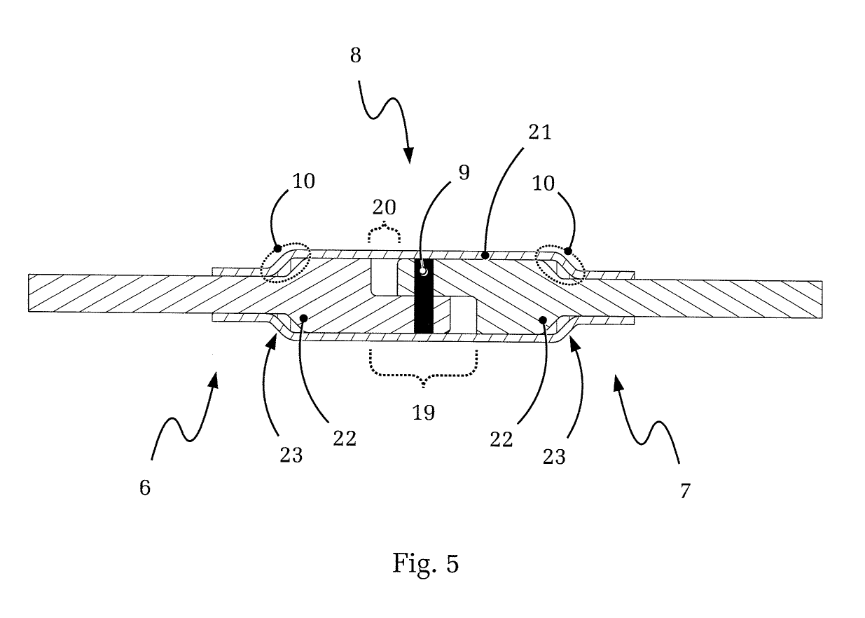

FIG. 5 shows a further embodiment of a link element having overload protection means according to the invention. In the embodiment according to FIG. 5, the shear element is also formed by a shear pin 9 as in the embodiments according to FIGS. 2 and 3. In the embodiment according to FIG. 5, the shear pin 9 extends through both link sections 6, 7 in an overlap region 19 and thereby rigidly connects the two link sections 6, 7 to each other in a form locking manner in normal operation of the link element. In the event of an overload, the shear pin 9 is sheared off, and, in the embodiment according to FIG. 5 as well, a limited axial path of relative movement between the two link sections 6, 7 results.

The link element according to FIG. 5 is double-acting, i.e. overload that occurs either in the tension direction or in the pressure direction causes the shear pin 9 to be sheared off, with the subsequent provision of a limited axial path of relative movement. The axial path of relative movement is limited in the pressure direction by the distance 20 between the particular end face of the particular link section and the projection on the particular other link section disposed opposite the end face. The axial path of relative movement is also limited in the tension direction in that, after failure of the shear pin 9 in the event of an overload in the tension direction, particular diameter jumps or radial projections 22 of the link sections 6, 7 impact corresponding radial indentations 23 in the regions of the housing 21 characterized by reference symbol 10.

In the embodiment of the link element according to FIG. 5, the housing 21 enclosing the overload protection means 8 is structurally multifunctional. For example, the housing 21 limits the axial path of relative movement between the two link sections 6, 7 in the event of an overload in the tension direction, and the housing 21, due to the contact thereof against all sides in the region of the ends of the link sections 6, 7, stiffens the link element in the region of the overload protection means 8 against bending in particular, and, finally, the housing 21 protects the overload protection means 8 against environmental influences and corrosion.

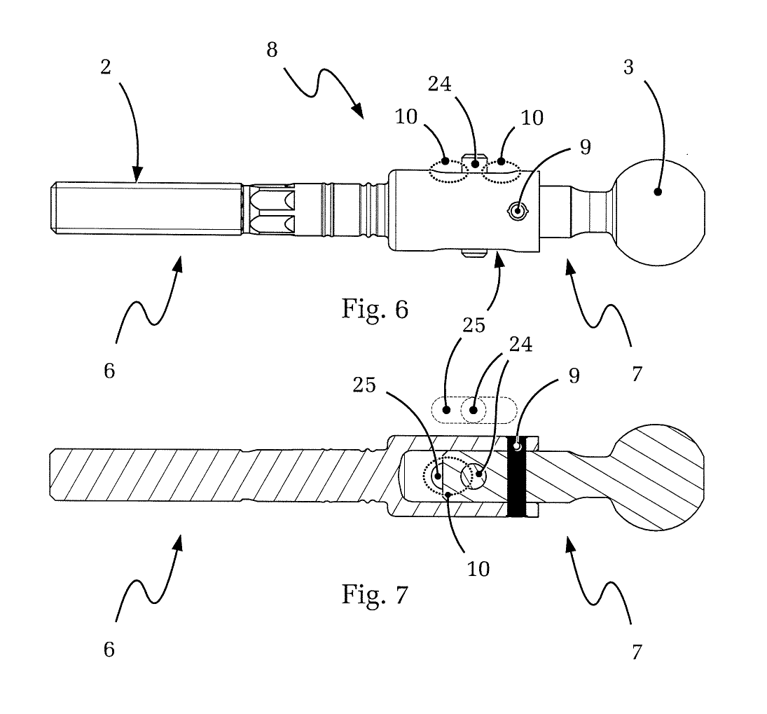

A further embodiment of a link element having an overload protection means according to the invention is depicted in FIGS. 6 and 7. A shear pin 9, which extends through the ends of the two link sections 6, 7, is also used as the shear element in the embodiment according to FIGS. 6 and 7. The embodiment according to FIGS. 6 and 7 is also double-acting, i.e. the shear pin 9 is sheared off in the event of overload in either the tension direction or the pressure direction, with the subsequent provision of a limited axial path of relative movement. In the embodiment according to FIGS. 6 and 7, the axial path of relative movement is limited in the event of an overload by end stops 10, comprising a stop pin 24, which also extends through the ends of the two link sections 6, 7. The stop pin 24 is thereby pressed into one of the two link sections (the link section 7 shown on the right in the drawing in this case), while the stop pin 24 extends through the other link section (the link section 6 shown on the left in the drawing) in a slot 25. For clarity, the slot 25 and the stop pin 24 extending through the slot 25 are indicated separately once more in FIG. 7 using dashed lines.

In the event of an overload followed by the failure and shearing off of the shear pin 9, the left and right link sections 6 and 7 can therefore move freely with respect to one another along the axial path of relative movement until the stop pin 24 impacts the particular end of the slot 25.

The embodiment according to FIGS. 6 and 7 has the advantage, in particular, of a cost-favorable design and simple assembly. The advantage according to the invention of simple modular adaptability of the failure forces to the particular basic conditions and customer requirements is also retained in that the material and/or diameter of the shear pin 9 are selected accordingly.

It is therefore clear that the invention provides a link element having an overload protection means, which combines a modular adaptability with a defined and reproducible failure behavior in the event of an overload with emergency functionality after an overload has occurred, wherein, as a result of the invention, the driver can be immediately signaled at the steering wheel that damage or an overload has occurred, e.g. at a tie rod designed according to the invention, without any additional devices.

### LIST OF REFERENCE SYMBOLS

1 link section

2 threaded fitting

3 ball pin, joint ball

4 joint housing

5 connecting thread

6, 7 link section

8 overload protection means

9 shear pin, shear disk

10 axial stop device

11 radial projection

12 radial projection, radial indentation

13 sleeve-shaped region

14 cone fit

15 stop ring

16, 17 clamping ring

18 sleeve edge

19 overlap region

20 axial distance

21 housing

22 radial projection

23 radial indentation

24 stop pin

25 slot

1-18. (canceled)

19. A link element for coupling of two assemblies, the link element comprising:
first and second substantially rod-shaped link sections (6, 7) being connected to one another via an overload protection means (8) and being axially movable relative to one another in an event of an overload,
the overload protection means (8) having at least one modularly interchangeable metallic shear element (9) rigidly connecting the first and the second link sections (6, 7) in a form locking manner, and
the overload protection means (8) having at least one rigid end stop (10) for limiting axial relative movement of the first and the second link sections (6, 7) in the event of an overload.

20. The link element according to claim 19, wherein the shear element (9) is shearable along both axial directions of the link element.

21. The link element according to claim 19, wherein the first and the second link sections (6, 7) each have an end stop (10) which limit axial relative movement of the first and the second link sections with respect to one another.

22. The link element according to claim 19, wherein the first link section (6) and the second link section (7) are mutually coaxially engaged, in an overlapped region of the overload protection means (8), the second link section (7) is sleeve-shaped in the overlapped region and accommodates an end of the first link section (6) assigned to the overlapped region.

23. The link element according to claim 22, wherein the first and the second link sections (6, 7) form a cone fit (14) within the overlapped region.

24. The link element according to claim 19, wherein the shear element is a shear pin (9), and the first and the second link sections (6, 7) at least partially overlap one another, in an axial direction, in an overlapped region of the overload protection means (8).

25. The link element according to claim 24, wherein the shear pin (9), extends through the first and the second link sections (6, 7), in the overlapped region, along an entire diameter of the overlapped region.

26. The link element according to claim 19, wherein the shear element is a shear disk (9) which is disposed in an axial overlapped region of the first and the second link sections, and the shear disk (9) has a shape of a circular ring.

27. The link element according to claim 26, wherein the shear disk (9) is connected, in a form locking manner, to at least one of the first and the second link sections (6, 7) by a clamping ring (16, 17) which is disposed, in each case, at the respective link section (6, 7) in a form locking manner.

28. The link element according to claim 19, wherein the end stop (10) for limiting an axial path of relative movement, in an event of an overload along at least one axial direction of the first and the second link sections, is formed by two axially separated inner (11) and outer radial projections (12) of the overload protection means (8), the inner radial projection (11) is disposed integrally on the first link section (6) within an axial overlapped region of the first and the second link sections, and the outer radial projection (12) is disposed integrally on a clamping ring (16) which forms part of the second link section (7).

29. The link element according to claim 19, wherein the end stop (10), for limiting an axial path of relative movement in an event of an overload along at least one axial direction, is formed by two axially separated inner (11) and outer radial projections (12) of the overload protection means (8), the inner radial projection (11) is disposed integrally on the first link section (6) within an overlap region of the first and the second link sections, and the outer radial projection (12) is disposed integrally, in a form of a radially shaped indentation (12), on the second link section which is sleeve-shaped in the overlapped region.

30. The link element according to claim 19, wherein the end stop (10), for limiting an axial path of relative movement in an event of an overload along at least one axial direction is formed by two axially separated inner (11) and outer radial projections (12) of the overload protection means (8), the inner radial projection (11) is integrally disposed on the first link section (6) within an axial overlapped region of the first and the second link sections, and the outer radial projection (12) is disposed on the second link section (7), which is sleeve-shaped in the overlapped region, and is in a form of a radially integrally formed stop ring (15).

31. The link element according to claim 19, wherein the overload protection means (8) and the shear element are disposed in a protective housing (21) which encloses the link element in a region of the overload protection means (8).

32. The link element according to claim 31, wherein the protective housing (21) encloses the overload protection means (8) having the shear element (9), and forms contact on all sides, and radially encloses ends of the first and the second link sections acting on the overload protection means (8).

33. The link element according to claim 31, wherein the end stop (10), for limiting an axial path of relative movement in an event of an overload along at least one axial direction, is formed by axially separated inner (22) and outer axial projections (23), the inner radial projection (22) is disposed integrally on at least one of the first and the second link sections (6, 7), and the outer radial projection (23) is formed by a radial indentation (23) of the protective housing (21).

34. The link element according to claim 19, wherein the end stop (10), for limiting an axial path of relative movement in an event of an overload along at least one axial direction, is formed by a stop pin (24) which radially extends through the first and the second link sections (6, 7), in an axial overlapped region of the first and the second link sections, the stop pin extends through at least one of the first and the second link sections (6, 7), in the overlapped region, in an axially oriented slot (25).

35. The link element according to claim 19, wherein at least one of the first and the second link sections (6, 7) is designed at an end (13) thereof facing away from the overload protection means (8) to accommodate, in a form locking manner, either a further link section or a shank (3) of a ball joint.

36. The link element according to claim 19, wherein at least one of the first and the second link sections (6, 7) is formed integrally with a joint ball (3) at an end thereof facing away from the overload protection means (8).

37. A link element for a tie rod for coupling two assemblies with one another, the link element comprises:
first and second link sections that are coaxially aligned with one another, one end of the second link section overlaps one end of the first link section in an overlapped region, the ends of the first and the second link sections contact one another in the overlapped region, and the first and the second link sections being axially movable with respect to one another;
a metallic shear element axially fixes the first and the second link sections to one another, and when the first and the second link sections are subject to an overload, the shear element shears to facilitate axial movement of the first and the second link sections with respect to one another; and
the first and the second link sections having at least one rigid end stop which limits a range of axial movement of the first and the second link sections, with respect to one another, following shearing of the shear element.
